(19) United States
(12) Patent Application Publication
(10) Pub. No.: US 2004/0150617 A1
(43) Pub. Date: Aug. 5, 2004

(54) Image projector having a grid display device

(75) Inventor: Youichi Tamura, Tokyo (JP)

Correspondence Address: YOUNG & THOMPSON, 745 SOUTH 23RD STREET 2ND FLOOR, ARLINGTON, VA, 22202

(73) Assignee: NEC VIEWTECHNOLOGY, LTD, Tokyo (JP)

(21) Appl. No.: 10/358,148

(22) Filed: Feb. 5, 2003

(51) Int. Cl. G09G 5/00

(52) U.S. Cl. 345/156

(57) ABSTRACT

An image projector includes a grid display device and projects the image formed on the grid display device onto a screen. While projecting a test image onto the screen to form distorted image thereon, four apexes of the screen is pointed by a pointing device. The image projector calculates correction parameters based on the differences of the coordinates between the specified apexes and the apexes of the distorted image, and corrects a desired image based on the correction parameters.

### BACKGROUND OF THE INVENTION

(a) Field of the Invention

The present invention relates to an image projector and, more particularly, to an improvement of an image correction unit in the image projector for correcting a distortion of the image to be projected by the image projector. The present invention also relates to a method for correcting a distortion in a projected image on a screen.

(b) Description of the Related Art

An image projector of a grid display type has a grid display device such as a liquid crystal display (LCD) device or a digital micromirror device (DMD), and projects the image formed on the grid display device onto a screen via radial light through a projection lens.

The projection of the image by the image projector of the grid display type is often conducted in a direction skewed vertically, i.e., upward or downward, away from the direction normal to the plane of the screen. In such a case, the image projected by the image projector onto the screen has therein a distortion, wherein the overall rectangular image area is changed to a trapezoid image area.

In view of the above, an image correction unit is generally provided in a conventional image projector to correct the trapezoid image area into a rectangular image area. The image correction unit in the conventional image projector includes a first correction block for correcting the distortion on the screen generated upon the upward image projection and a second correcting block for correcting the distortion generated upon the downward image projection. The operator for the image projector generally uses one of the first and second correction blocks by directly depressing a corresponding push button on the image projector or using a remote control switch to thereby correct the distortion of the image projected by the image projector.

It is to be noted that the image projector is generally placed in front of the screen away from the location of viewers viewing the image on the screen, to thereby avoid obstruction of the field of view of the viewers. This restricts the location of the image projector, whereby the image projector is often placed at the location at which the image projector projects the image in a direction skewed horizontally away from the direction normal to the screen.

Thus, the image projector often projects the image in the direction skewed vertically and horizontally away from the direction normal to the screen. In such a case, as shown in FIG. 6, the overall rectangular image area to be projected by the image projector 10A is distorted on the screen to change into a roughly rhomboid image area 30.

The rhomboid image area cannot be corrected by the image correction unit in the conventional image projector as described above. Although some operator having specialized knowledge about the operation of the image projector may correct such a rhomboid image area, it is difficult for an average operator to correct the rhomboid image area into a correct rectangular image area.

### SUMMARY OF THE INVENTION

It is therefore an object of the present invention to provide an image projector having a function for correcting the image projected by the image projector as by correcting the rhomboid image area into a correct rectangular image area.

It is another object of the present invention to provide a method for correcting a distortion in a image projected on a screen by an image projector of a grid display type

The present invention provides an image projector including: a projection unit including a grid display device for forming an image thereon, the projection unit projecting the image formed on the grid display device onto a screen to display a projected image thereon; a pointing device for specifying, through the grid display device, a position with respect to the screen; a coordinate input section for receiving coordinates of a plurality of positions specified by the pointing device and coordinates of pixels corresponding to particular positions of the projected image, the coordinates being defined on the grid display device; and a correction parameter calculating section for calculating correction parameters based on differences between coordinates of the specified positions and coordinates of the pixels of the particular positions.

The present invention also provides a method for correcting an image to be projected onto a screen by an image projector including a grid display device, the method including the steps of: projecting a test image formed on the grid display device onto the screen; specifying a plurality of positions with respect to the screen by using a pointer through the grid display device; receiving coordinates of the specified positions on the grid display device and coordinates of pixels corresponding to particular positions of the test image; calculating correction parameters based on the coordinates of the specified positions and coordinates of the pixels; and correcting a desired image on the grid display device based on the correction parameters to obtain a corrected image on the screen.

The present invention also provides a method for correcting an image to be projected onto a screen by an image projector including a grid display device, the method including the steps of: projecting a test image formed on the grid display device onto the screen; specifying a plurality of pairs of positions with respect to the screen by using a pointer through the grid display device; receiving coordinates of the specified pairs of positions on the grid display device; calculating correction parameters based on the differences of the coordinates between each of the pairs of positions; and correcting a desired image on the grid display device based on the correction parameters to obtain a corrected image on the screen.

In accordance with the image projector and the method of the present invention, distortion of a desired image can be corrected by using correction parameters, which are obtained by projecting a test image and specifying positions on the screen by the operator in the projected image.

The term “image projector” as used herein means a projector having a grid display device, such as an LCD device or DMD, and is capable of projecting the image formed on the grid display device onto a screen to provide a projected image on the screen. The screen may be of a light reflection type or a light transmission type.

The above and other objects, features and advantages of the present invention will be more apparent from the following description, referring to the accompanying drawings.

### BRIEF DESCRIPTION OF THE DRAWINGS

FIG. 1 is a schematic block diagram of an image projector according to an embodiment of the present invention.

FIG. 2 is a perspective view showing the image projector of FIG. 1 and the test image projected by the image projector and having a distortion therein.

FIG. 3 is an explanatory diagram of the image area showing the specified positions in the test image.

FIG. 4 is an explanatory diagram of the corrected test image.

FIG. 5 is a flowchart of a procedure for correcting the image in the image projector of the embodiment.

FIG. 6 is a perspective view showing the distortion of the image projected by a conventional image projector.

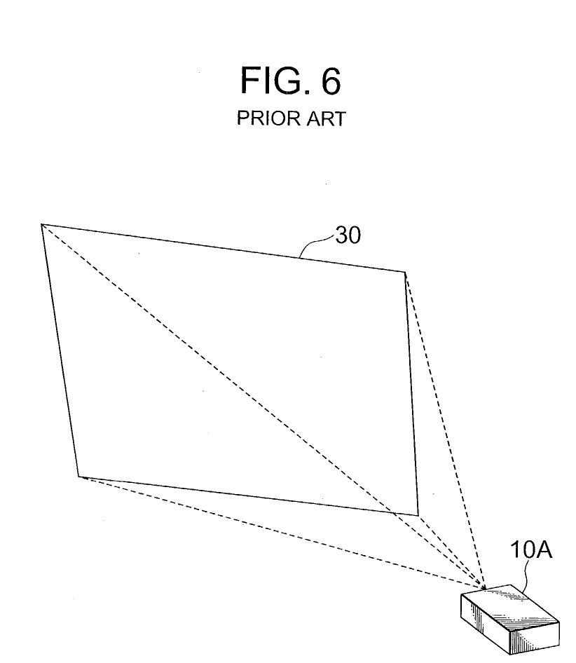

### PREFERRED EMBODIMENTS OF THE INVENTION

Now, the present invention is more specifically described with reference to accompanying drawings.

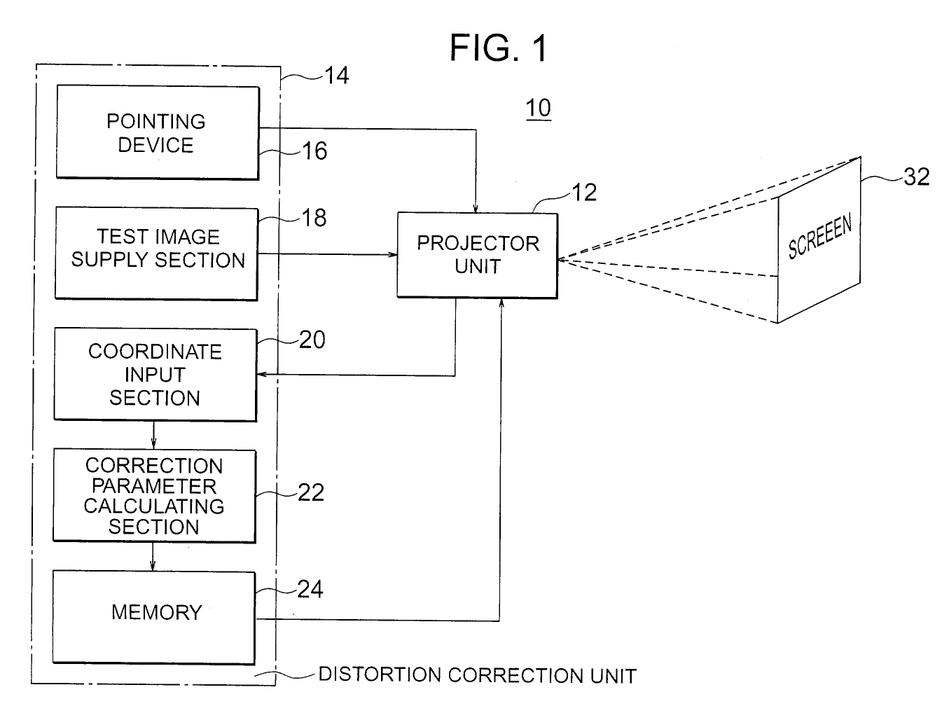

Referring to FIG. 1, an image projector, generally designated by numeral 10, according to an embodiment of the present invention includes a projector unit 12 for projecting an image onto a screen 32, and a distortion correction unit 14 associated with the projector unit 12. The distortion correction unit 14 includes a pointing device 16, a test image supply section 18, a coordinate input section 20, a correction parameter calculating section 22, and a memory 24.

The projector unit 12 includes therein a grid display device such as a LCD device or a DMD, and emits radial light to the screen 32 through a projection lens, the radial light including the image formed on the grid display unit, to thereby display a projected image on the screen.

The distortion correction unit 14 generates and stores correction parameters for correcting the projected image to be displayed on the screen, i.e., correcting a distortion caused by a projection optical axis of the projector unit 12 being skewed horizontally and vertically away from the direction normal to the screen.

The pointing device 16 may be a mouse, which moves a pointer on the screen 32 through the grid display device of the projector unit 12 to specify desired locations such as four apexes of a rectangle, for example, which corresponds to the image area of the screen 32.

The test image supply section 18 provides test image data to the projection unit 12, and allows the projection unit 12 to project a test image on the screen 32. The test image supply section 18 may be a disk storing therein a test image, which may be any image such as a dedicated test image or an image to be projected by the image projector 10. The test image has a contour of a geographical figure, such as a blank polygon and typically a blank rectangle, having a plurality of apexes that define the contour of the image area and have definite geometrical relationships therebetween.

The coordinate input section 20 receives the coordinates of the apexes specified by the pointing device 19 on the screen 32 and apexes of the contour of the test image in terms of the coordinates on the grid display device in the projection unit 12.

The correction parameter calculating section 22 first calculates the differences between the coordinates of the four apexes of the distorted rectangle and the coordinates of the four apexes of the screen received by the coordinate input section 20, these coordinates being defined on the grid display device of the projector unit 12. The correction parameter calculating section 22 then calculates the correction parameters for respective pixels (grid points) of the grid display device based on the differences as by using an interpolation technique, and stores the calculated correction parameters in the memory 24 such as a frame memory.

The correction parameters of respective pixels are used for coordinate conversion, which allows the pixels at the four corners of the test image corresponding to the four apexes of the rhomboid image to project images onto the positions specified by the pointing device, and allows the other pixels to project images onto respective modified positions.

In the present embodiment, the coordinates of the four corners of the test images and the coordinates of the corner of the screen are received by the coordinate input section. However, the apexes of the grid display device may be stored beforehand in the correction parameter calculating section 22 instead of the projecting a test image. Alternatively, the pointing device 16 may be used to shift a pointer on the screen 32 from each apex of the screen 32 to a corresponding apex of the projected image, i.e., distorted image area of a rhomboid. In such a case, the coordinate input section 20 receives coordinates of each pair of the specified locations, whereby the correction parameter calculating section 22 calculates the correction parameters based on the difference between the coordinates of each pair.

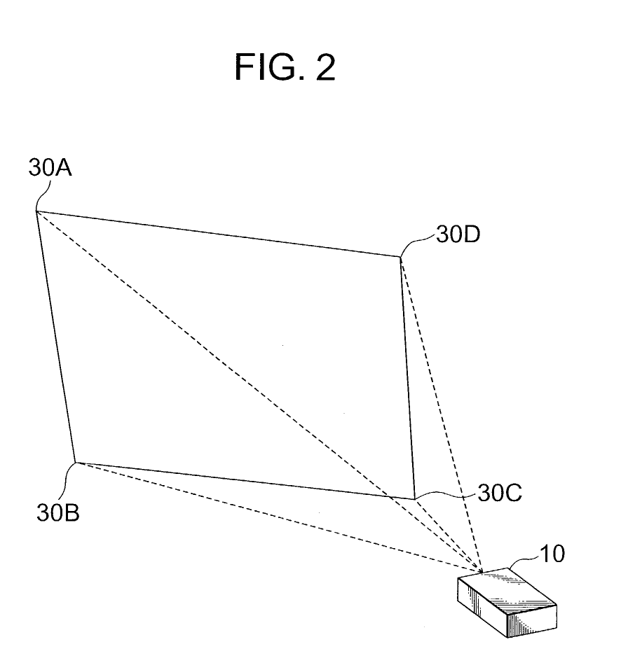

The operation of the distortion correction unit 14 will be described in detail with reference to FIGS. 2 to 5. The test image supply section 18 delivers test image data defining a rectangular image area to the projection unit 12, which projects a test image based on the test image data. The test image 30 projected by the image projector 10 onto the screen 32 is of a substantially rhomboid due to a distortion, as shown in FIG. 2. The rhomboid image or distorted rectangular image 30 has four apexes 30A to 30D.

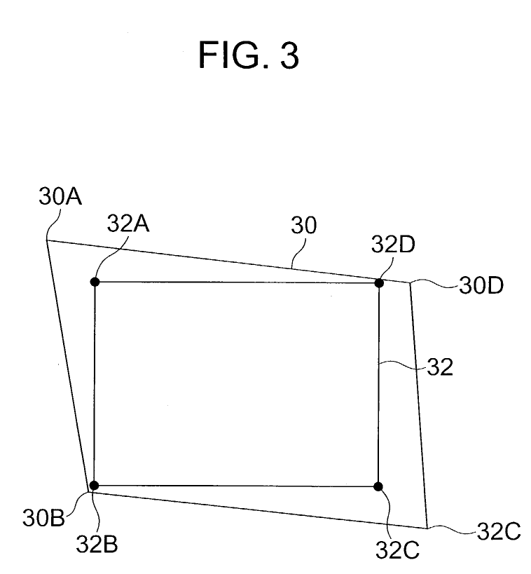

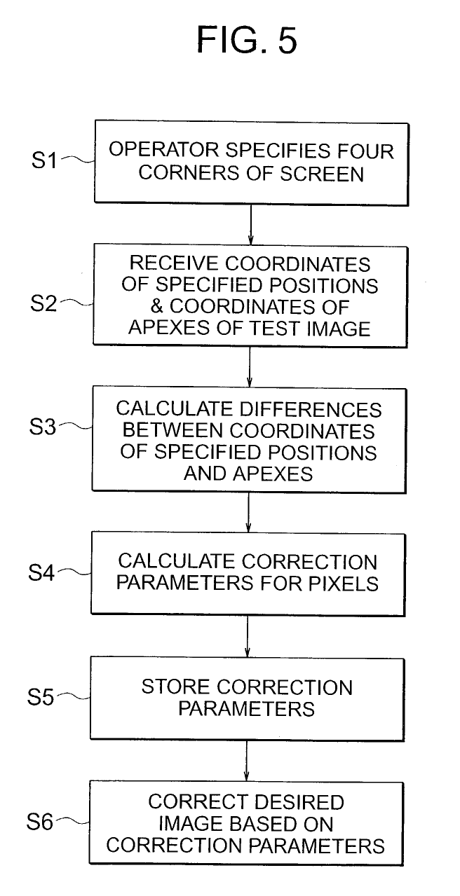

The operator then uses the pointing device 16, such as a mouse, to specify four corners 32A to 32D of the screen 32 at the pointer (step S1 in FIG. 5), as shown in FIG. 3. The coordinate input section 20 then receives the coordinates of the specified four corners 32A to 32D of the screen 32 and the four apexes of the test image on the plane of the grid display device (step S2 in FIG. 5).

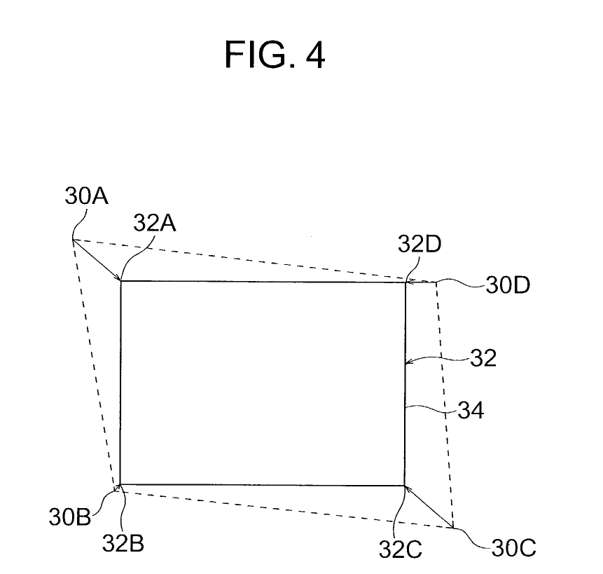

The correction parameter calculating section 22 then calculates the differences between the coordinates of the four apexes of the test image corresponding to the apexes 30A to 30D of the distorted rectangular image 30 and the four corners 32A to 32D of the screen 32, on the plane of the grid display device (step S3 in FIG. 5). The correction parameter calculating section 22 then calculates correction parameters for converting the coordinates of the grid points corresponding to the four apexes 30A to 30D of the distorted rectangular image 30 into coordinates of the grid points corresponding to the four corners 32A to 32D of the screen 32, as shown in FIG. 4, as well as converting the coordinates of the remaining grid points to the converted coordinates (step S4 in FIG. 5). The correction parameter calculating section 22 then stores the calculated correction parameters for the respective coordinates in the memory 24 of the distortion correction unit 14 (step S5 in FIG. 5), thereby ending the test projection.

When a desired image is to be projected on the screen, with the location of the image projector 10 being fixed, the coordinates of the grid points are corrected based on the correction parameters to correct the distortion caused by the skew of the optical axis with respect to the direction normal to the screen 32 (step S6 in FIG. 5).

In the above embodiment, the four corners 32A to 32D of the screen 32 are employed for correcting the image; however, desired points may be used for correction instead of or in addition to the four corners 32A to 32D.

In addition, the test image may be any image to be projected on the screen. In such a case, the horizontal to vertical ratio of the rectangular image can be selected at any ratio as desired irrespective of the ratio of the image in the image data for modification of the image.

Further, the test image supply section 18 may be included in the projector unit 12.

Since the above embodiments are described only for examples, the present invention is not limited to the above embodiments and various modifications or alterations can be easily made therefrom by those skilled in the art without departing from the scope of the present invention.

What is claimed is:

1. An image projector comprising:
a projection unit including a grid display device for forming an image thereon, said projection unit projecting the image formed on said grid display device onto a screen to display a projected image thereon;
a pointing device for specifying, through said grid display device, a position with respect to the screen;
a coordinate input section for receiving coordinates of a plurality of positions specified by said pointing device and coordinates of pixels corresponding to particular positions of the projected image, the coordinates being defined on said grid display device; and
a correction parameter calculating section for calculating correction parameters based on differences between coordinates of said specified positions and coordinates of said pixels.

2. The image projector according to claim 1, further comprising a storage section for storing the correction parameters, said projection unit correcting a desired image based on the correction parameters stored in said storage section.

3. The image projector according to claim 1, wherein said storage section is a frame memory for storing the correction parameters for respective grid points of the grid display device.

4. The image projector according to claim 3, wherein the correction parameters are used for coordinate conversion.

5. A method for correcting an image to be projected onto a screen by an image projector including a grid display device, the method comprising the steps of:
projecting a test image formed on the grid display device onto the screen;
specifying a plurality of positions with respect to the screen by using a pointer through the grid display device;
receiving coordinates of the specified positions and coordinates of pixels corresponding to particular positions of the projected image, the coordinates being defined on the grid display device;
calculating correction parameters based on the differences between the coordinates of the specified positions and the coordinates of said pixel; and
correcting a desired image on the grid display device based on the correction parameters to obtain a corrected image on the screen.

6. The method as defined in claim 5, wherein the predetermined positions include positions corresponding to apexes of the projected image.

7. A method for correcting an image to be projected onto a screen by an image projector including a grid display device, the method comprising the steps of:
projecting a test image formed on the grid display device onto the screen;
specifying a plurality of pairs of positions by using a pointer through the grid display device;
receiving coordinates of the specified pairs of positions on the grid display device;
calculating correction parameters based on the differences of the coordinates between each of the pairs of positions; and
correcting a desired image on the grid display device based on the correction parameters to obtain a corrected image on the screen.

8. The method as defined in claim 7, wherein, each of pairs corresponds to a corner of the screen and a corresponding apex of the projected image.
